(19) United States
(12) Patent Application Publication
(10) Pub. No.: US 2025/0212311 A1
(43) Pub. Date: Jun. 26, 2025

(54) STRUCTURE AND METHOD FOR CONCENTRATING PLASMA FOR INJECTION INTO A REACTION CHAMBER

(71) Applicant: IBSS Group, South San Francisco, CA (US)

(72) Inventors: Lua Larry Tran, South San Francisco, CA (US); Vincent Carlino, South San Francisco, CA (US); Chris Newell, South San Francisco, CA (US); Enric Bertran-Serra, Barcelona (ES)

(21) Appl. No.: 18/395,115

(22) Filed: Dec. 22, 2023

(51) Int. Cl. H05H 1/46

(52) U.S. Cl. CPC H05H 1/4652

(57) ABSTRACT

A plasma generation assembly in a plasma source powered by an external radio-frequency (RF) power source, which includes (a) a plasma generation chamber having an inlet end and an outlet end, the inlet end being configured to receive a reactive gas and an outlet end being configured to provide one or more plasma-state reactive species through a conduit to an external reaction chamber; and (b) a coil or solenoid provided coaxially enclosing the plasma generation chamber, wherein the coil or solenoid is configured to receive an electric current from the RF power source, wherein the coil or solenoid has a turns ratio that varies along the axial length of the coil or solenoid.

### BACKGROUND OF THE INVENTION

### 1. Field of the Invention

The present invention relates to a design for a plasma or glow discharge generation chamber (“plasma generation chamber”), in which reactive gases are ionized into reactive species in a plasma state and supplied to a downstream reaction chamber where the reactive species participate in a chemical reaction, such as a cleaning application.

### 2. Discussion of the Related Art

FIG. 1 shows schematically conventional plasma system 100, which is suitable for use, for example, in a cleaning application. As shown in FIG. 1, various functional components of plasma system 100 are illustrated: (a) plasma generation chamber 105, (b) reaction chamber 103, (c) aperture disc 102, which includes conduit 106 connecting plasma chamber 105 and reaction chamber 103, (d) “coil” or solenoid 101, (e) matching network 104, and (d) radio frequency (RF) power source 107. Typically, plasma generation chamber 105 is implemented in a cylindrical tube (“inductively coupled tube”).

To facilitate the following description of system operations, FIG. 1 shows plasma generation chamber 105, aperture disc 102, solenoid 101 and reaction chamber 103 in a cross section along the longitudinal axis of plasma chamber 105. Typically, reactive gases (e.g., oxygen-based gases, halogen-based gases, or any suitable reactive gases) are supplied from inlet 108 under a controlled pressure and a controlled flow rate—with or without a non-reactive carrier gas (e.g., argon (Ar) or nitrogen (N₂))—into plasma generation chamber 105, where it is energized by a magnetic field created by an electrical current flowing in solenoid 101. The energized reactive gases transition into various reactive species in a plasma state (i.e., an ionized gaseous state). Plasma generation chamber 105 and reaction chamber 103 are connected by aperture disc 102. Conduit 106 in aperture disc 102 allows the reactive species to enter reaction chamber 103. Inside reaction chamber 103, the reactive species participate in a chemical reaction. In one cleaning application, for example, the reactive species may react in reaction chamber 103 with undesirable deposits on the surfaces of vacuum chambers and on items inside an equipment. The resulting compounds thus formed, typically gaseous and volatile, are then evacuated as effluent gases from reaction chamber 103.

As known to those of ordinary skill in the art, the electrical current in solenoid 101 is typically driven from matching network 104, which matches the impedances of plasma system 100 to RF power source 107, thereby ensuring that energy received from RF power source 107 is inductively coupled into an axial magnetic field (“RF field”) in plasma generation chamber 105 in an efficient manner. This RF field—which determines the plasma density in plasma generation chamber 105—is roughly uniform along the length of plasma chamber 105 because of the substantially uniform turns ratio in solenoid 101.

U.S. Pat. No. 7,015,415 to G. Gorin (the “'415 patent”), entitled “Higher Power Density Downstream Plasma,” issued Mar. 21, 2006, discloses constricting conduit 106 to increase power density in the vicinity of conduit 106. To that extent, the '415 patent discloses an “inside diameter [for conduit 106] ranging from one millimeter (mm) to less than 19 millimeters, and a [longitudinal length of conduit 106 to be] substantially equal to or greater than one millimeter” (the '415 patent, at col. 5, lines 5-9). The '415 patent, however, provides not teaching as how the configuration of plasma generation chamber 105 may help to optimize its power density and, hence, affect the reaction rates in the reaction chamber 103.

### SUMMARY

According to one embodiment of the present invention, a plasma generation assembly in a plasma source powered by an external radio-frequency (RF) power source includes: (a) a plasma generation chamber having an inlet end and an outlet end, the inlet end being configured to receive a reactive gas and an outlet end being configured to provide one or more plasma-state reactive species through a conduit to an external reaction chamber; and (b) a coil or solenoid provided coaxially enclosing the plasma generation chamber, wherein the coil or solenoid is configured to receive an electric current from the RF power source, wherein the coil or solenoid has a turns ratio that varies along the axial length of the coil or solenoid. The electric current generates a magnetic field in the plasma generation chamber to ionize the reactive gas, thereby creating the plasma-state reactive species at the outlet end. The plasma generation chamber may be formed in a quartz tube or a ceramic tube.

The plasma generation assembly may include an aperture disc at the outlet end of the plasma generation chamber, wherein the conduit is provided as an aperture in the aperture disc. According to one embodiment of the present invention, the aperture of the aperture disc may be a selected one of a plurality of desirable diameters.

According to one embodiment of the present invention, the turns ratio of the coil or solenoid is greater at the outlet end of the plasma generation chamber than at the inlet end of the plasma generation chamber.

According to one embodiment of the present invention the plasma generation chamber may include various metalized parts that are attached and sealed using a brazing technique, so as to ensure vacuum-sealing of the plasma generation chamber during operation. The plasma generation assembly may include a mounting flange that connects the external reaction chamber to the plasma generation chamber. The mounting flange may be formed out of stainless steel. Metalized bellows may be provided to attach the mounting flange to the plasma generation chamber.

These and other advantages, aspects, and novel features of the present invention, as well as details of an illustrated embodiment thereof, will be more fully understood upon consideration of the following description and drawings.

### BRIEF DESCRIPTION OF THE DRAWINGS

FIG. 1 shows schematically conventional plasma system 100 suitable for use, for example, in a cleaning application.

FIGS. 2A-2B show, respectively, a side view and a longitudinal cross-section view of glow discharge generation chamber 205, in accordance with one embodiment of the present invention.

FIGS. 2C-2D show, respectively, a side view of a ceramic tube housing plasma generation chamber 205 and an axial plane view of aperture disc 202, in accordance with one embodiment of the present invention.

FIGS. 3A-1 and 3A-2 show, respectively, the qualitative density distributions of the reactive species in the plasma state in plasma generation chamber 105 of conventional plasma system 100 and in plasma generation chamber 205 of convention plasma system 200 of the present invention.

FIG. 3B shows the dispersion of reactive species in the plasma state indicated by directional vectors of flow, as the reactive species flow into reaction chamber 203 through conduit 206 in plasma system 200, according to one embodiment of the present invention.

FIG. 3C shows the resulting qualitative density distributions of reactive species in the plasma state in reaction chamber 203 of plasma system 200 of the present invention.

FIGS. 3D-1 and 3D-2 show, respectively, the qualitative density distributions of reactive species in the plasma state in reaction chamber 103 of conventional plasma system 100 and in reaction chamber 203 of plasma system 200 of the present invention, after a predetermined elapsed time.

FIG. 4 illustrates a plasma generation assembly 500 assembled using brazed inductively coupled tube assembly, according to one embodiment of the present invention.

Various embodiments of the invention are disclosed in the following detailed description and the accompanying drawings. Although the drawings depict various examples of the invention, the invention is not limited by the depicted examples. It is to be understood that, in the drawings, like reference numerals designate like structural elements. Also, it is understood that the depictions in the FIGS. are not necessarily to scale.

### DETAILED DESCRIPTION OF THE PREFERRED EMBODIMENTS

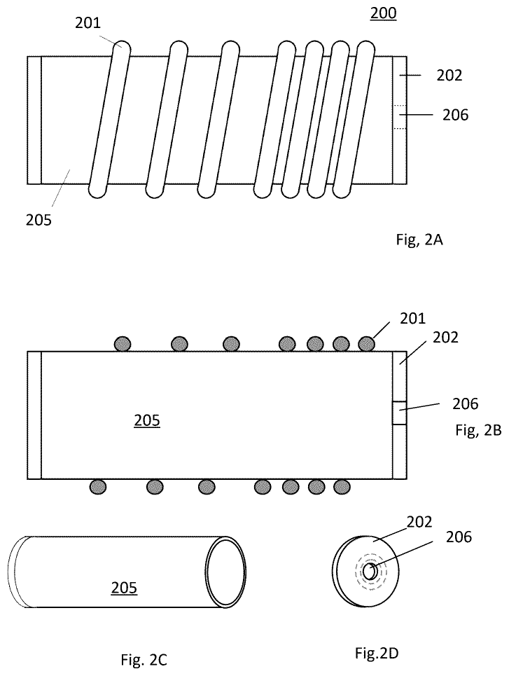

FIGS. 2A-2D illustrate plasma chamber 205 of plasma system 200, according to one embodiment of the present invention. Specifically, FIGS. 2A-2B show, respectively, a side view and a longitudinal cross-section view of plasma generation chamber 205, solenoid 201 and aperture disc 202. Aperture disc 202 includes conduit 206, which allows the reactive species in the plasma state to flow into reaction chamber 203 (not shown). In one embodiment, the inductively coupled tube of plasma generation chamber 205 may be implemented by a ceramic or quartz tube (e.g., a sapphire tube), to allow operation at temperatures up to a desired temperature (e.g., a few hundred degrees Celsius).

In one embodiment, plasma system 200 may operate with a power input rated at up to 300 W. A desirable operating pressure in the inductively coupled tube of plasma generation chamber 205 for a cleaning application may be, for example, 7.0 mTorr. In one cleaning application, an oxygen-containing gas may be used to generate reactive species in the plasma state to remove carbonaceous contamination. For example, in some instances, atmospheric air is used as a “plasma driving gas.” Some components of the plasma driving gas (e.g., oxygen and nitrogen in air) may be ionized in plasma generation chamber 205 to become reactive species. Alternatively, pure molecular oxygen (O₂) gas may be used. The reactive species in the plasma state include, for example, atomic oxygen (O), O₂⁺, O⁺ and O⁻. Each of these reactive species is more reactive than the molecular oxygen gas from which it is formed. In another cleaning application, molecular hydrogen (H₂) may be used. The reactive gas may be provided in a mixture that includes non-reactive gas or gases, such as argon (Ar).

FIGS. 2C-2D show, respectively, a side view of the inductively coupled tube of plasma generation chamber 205 and an axial plane view of aperture disc 202. The inductively coupled tube of plasma generation chamber 205 may have, for example, a 1.0-inch outer diameter. In some embodiments, conduit 206 of aperture disc 202 may be customized to have any one of several diameters. The dash lines in FIG. 2D surrounding conduit 206 indicated the various diameters conduit 206 may be provided. In one embodiment, conduit 206 may have an 0.2-inch diameter, which is significantly larger than the 0.2 mm diameter suggested by the '415 patent. The inductively coupled tube of plasma generation chamber 205 may have separately provided aperture discs at its inlet and outlet (i.e., a 3-piece inductively coupled tube). Alternatively, the aperture discs may be permanently fused with the inductively coupled tube using a metal/ceramic brazing process.

The inventor expects that the different aperture discs would provide different gas volumes that accumulate upstream of conduit 206. It is believed that the accumulated gas volume upstream of conduit 206 is inversely proportional to the ratio of the radius of conduit 206 to the radius of the inductively coupled tube. A greater gas volume accumulated upstream of conduit 206 would result in a greater pressure differential across conduit 206 (i.e., the greater pressure difference between plasma generation chamber 205 and reaction chamber 203) and a longer resident time of the reactive gases upstream of conduit 206, depending on the diameter of conduit 206 and the gas flow rates. An increased resident time of the reactive gases increases their exposure to the RF energy delivered by coil or solenoid 201, thereby increasing the density of resulting reactive species in the plasma state.

In addition, unlike conventional plasma systems, the turns-per-unit length (“turns ratio” or N/L) of solenoid 201 need not be uniform along its length. Specifically, the turns ratio may be made significantly higher in the vicinity of aperture disc 202, relative to further upstream in the inductively coupled tube. This configuration increases the intensity of the RF field around the volume of gas accumulated upstream of conduit 206, thereby increases the RF field's interaction with the gas volume, thus providing a greater density of plasma-state reactive species that may be introduced into reaction chamber 203. To summarize, the higher turns ratio increases the probability of ionization in the vicinity of aperture disc 202, relative to the probability of ionization further upstream in the inductively coupled tube. Consequently, the density of reactive species in the plasma state immediately upstream from aperture 206 is significantly higher than that of the prior art, for the same total gas volumes in the inductively coupled tube.

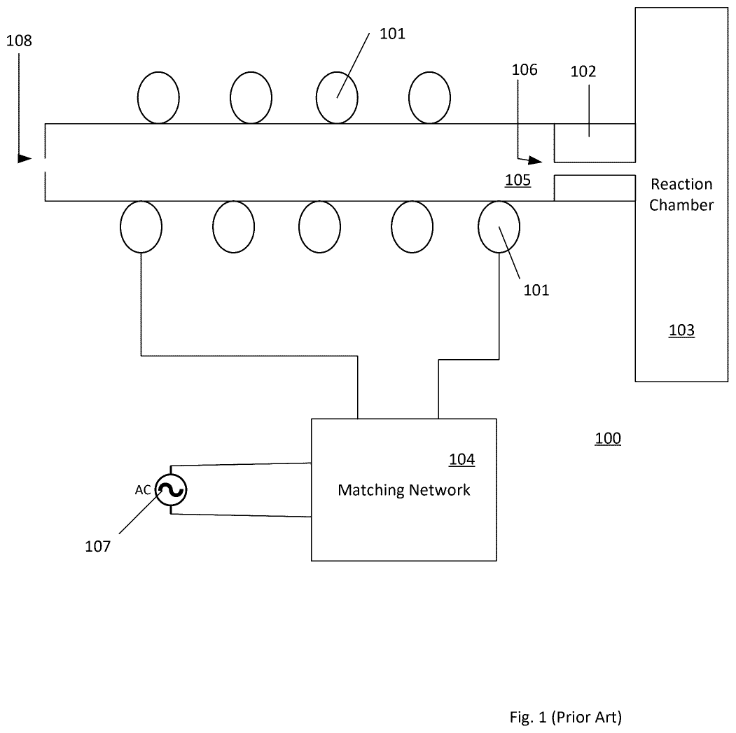

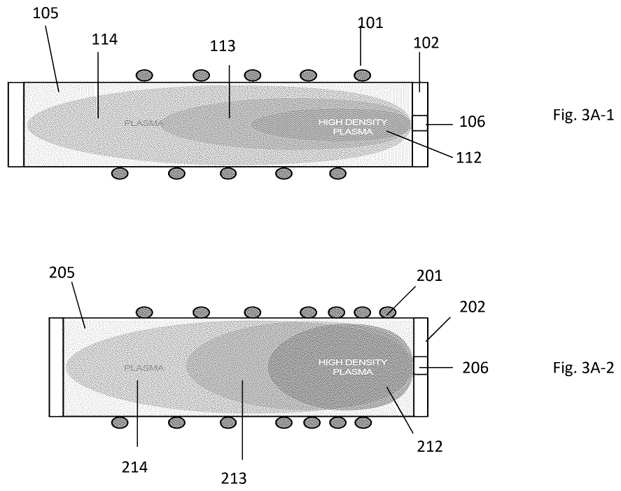

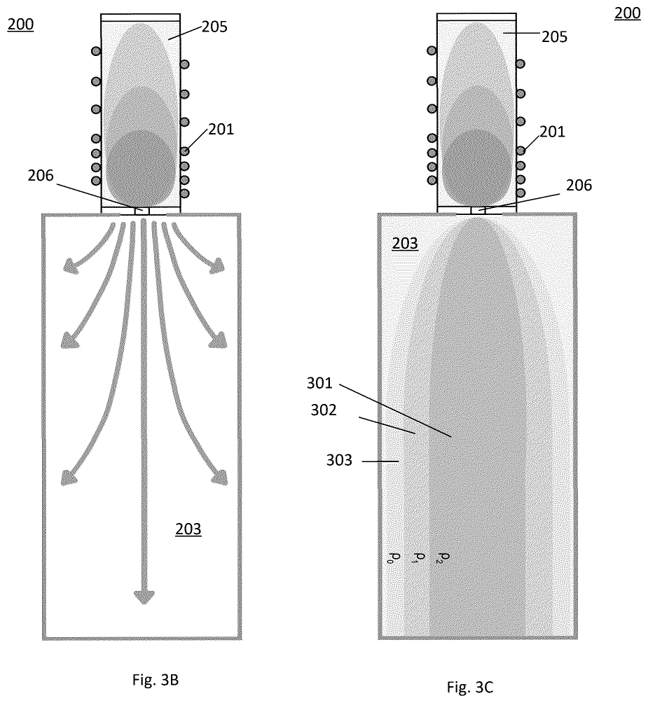

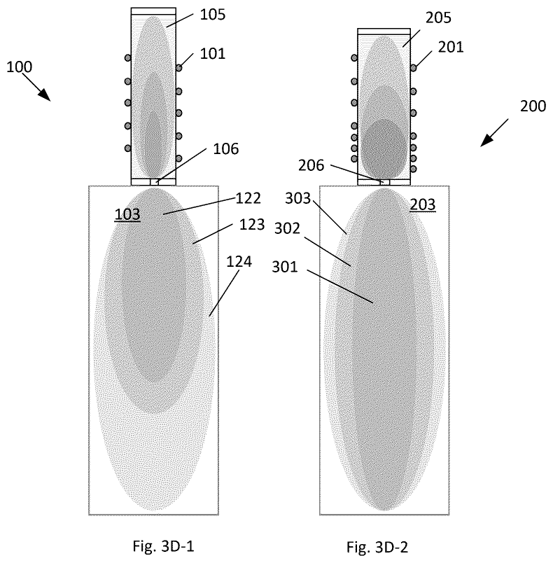

FIGS. 3A-1 and 3A-2 show, respectively, the qualitative density distributions of reactive species in the plasma state (a) in plasma chamber 105 of conventional plasma system 100, and (b) in plasma chamber 205 of plasma system 200 of the present invention. In FIG. 3A-1, zones 112, 113 and 114 represent the regions of high, medium and low densities of plasma state reactive species in the inductively coupled tube of plasma generation chamber 105. Likewise, in FIG. 3A-2, zones 212, 213 and 214 represent the regions of highest, median and lowest densities of plasma-state reactive species in the inductively coupled tube of plasma generation chamber 205. As shown in FIGS. 3A-1 and 3A-2, the volume of reactive species in zone 212 of plasma generation chamber 205 is significantly higher (e.g., greater than 20%) than the volume of reactive species in zone 112 of plasma generation chamber 105, reflecting a significantly higher inductive coupling in plasma system 200 due to the higher turns ratio in solenoid 201.

FIG. 3B shows the dispersion of reactive species in the plasma state indicated by directional vectors of flow, as the plasma-state reactive species flow into reaction chamber 203 through conduit 206 in plasma system 200, according to one embodiment of the present invention. In FIG. 3B, reaction chamber 203 is evacuated under a vacuum-chamber pump, as is known to the person of ordinary skill in the art.

FIG. 3C shows the resulting qualitative density distributions of plasma-state reactive species in reaction chamber 203 of plasma system 200 of the present invention. In FIG. 3C, zones 301, 302 and 303 respectively represent the regions of high, medium and low densities of reactive species in the plasma state in reactive chamber 203.

FIGS. 3D-1 and 3D-2 show, respectively, the qualitative density distributions of reactive species in the plasma state (a) in reaction chamber 103 of conventional plasma system 100, and (b) in reaction chamber 203 of plasma system 200 of the present invention, after a predetermined elapsed time of operation. In FIG. 3D-1, zones 122, 123 and 124 represent the regions of high, medium and low densities of plasma-state reactive species in reaction chamber 103. Likewise, in FIG. 3D-2, zones 301, 302 and 303 represent the regions of highest, median and lowest densities of plasma-state reactive species in reaction chamber 203. As shown in FIGS. 3D-1 and 3D-2, the volume of ionized reactive species in zone 301 of plasma generation chamber 203 is significantly higher than the volume of ionized reactive species in zone 122 of plasma generation chamber 103, reflecting a significant advantage of the present invention in delivering a higher volume of reactive species in the plasma state into the reaction chamber.

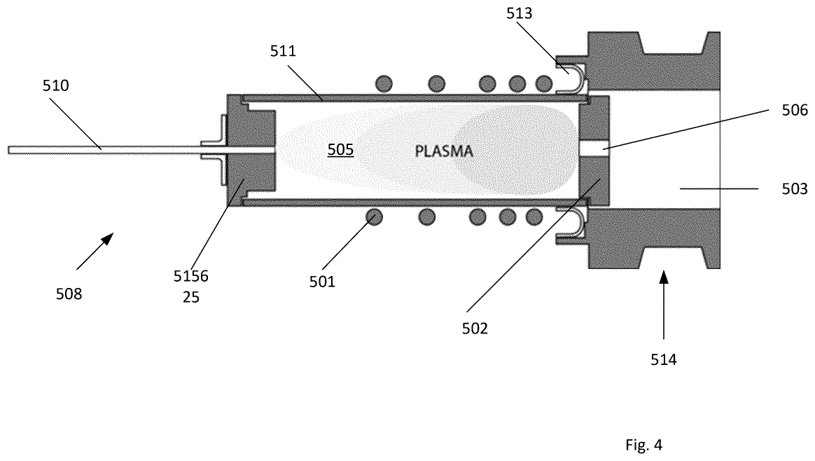

FIG. 4 illustrates a plasma generation assembly 500 assembled using brazed assembly, according to one embodiment of the present invention. As shown in FIG. 4, plasma generation assembly 500 includes (a) plasma generation chamber 505, implemented by ceramic tube 511 (as the inductively coupled tube), (b) inlet disc metalized assembly 508, (c) aperture disc 502, (d) mounting flange 514, and (e) coil or solenoid 501. Inlet disc metalized assembly 508 includes inlet tube 510—through which the reactive gas (e.g., O₂) enters plasma generation chamber 505—and inlet disc 515. Inlet tube 510 and inlet disc 515 are attached and sealed by metallic components that are put together and sealed using a brazing technique. Mounting flange 514, which allows plasma generation assembly 500 to be attached to reaction chamber 503, is attached to ceramic tube 511 by bellows 513. Aperture disc 502 may be any of several aperture discs, each providing a different desired diameter for conduit 506. Bellows 513 provides a metalized surface for attaching ceramic tube 511 to mounting flange 514, which may be formed out of stainless steel. Ceramic tube 511, mounting flange 514, bellows 513 and aperture disc 512 are also attached and sealed using the brazing technique.

The brazing technique ensures that inductively coupled tube 511 to be considerably more robust by eliminating the polymer seals (e.g., o-rings) that are customarily used in the prior art to provide air-tight seals. The robustness reduces the risk of vacuum leakage during high-power or prolonged operations. Moreover, the metalized sealing points characteristic of the brazing technique allows plasma generation assembly 500 to be attached onto ultra-high vacuum reaction chambers without using isolation valves and pre-pumps.

In this detailed description, various embodiments or examples of the present invention may be implemented in numerous ways. A detailed description of one or more embodiments of the invention is provided above along with accompanying figures that illustrate the principles of the invention. The invention is described in connection with such embodiments, but the invention is not limited to any embodiment. Numerous modifications and variations within the scope of the present invention are possible. The scope of the invention is limited only by the claims and the invention encompasses numerous alternatives, modifications, and equivalents. Numerous specific details are set forth in the description to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. The present invention is defined by the appended claims.

We claim:

1. A plasma generation assembly in a plasma source powered by an external radio-frequency (RF) power source, comprising:
a plasma generation chamber having an inlet end and an outlet end, the inlet end being configured to receive a reactive gas and an outlet end being configured to provide one or more plasma-state reactive species through a conduit to an external reaction chamber; and
a coil or solenoid provided coaxially enclosing the plasma generation chamber, wherein the coil or solenoid is configured to receive an electric current from the RF power source, wherein the coil or solenoid has a turns ratio that varies along the axial length of the coil or solenoid.

2. The plasma generation assembly of claim 1, wherein the electric current generates a magnetic field in the plasma generation chamber to ionize the reactive gas, thereby creating the plasma-state reactive species at the outlet end.

3. The plasma generation assembly of claim 1, further comprising an aperture disc at the outlet end of the plasma generation chamber, wherein the conduit is provided as an aperture in the aperture disc.

4. The plasma generation assembly of claim 1, wherein the aperture of the aperture disc may be a selected one of a plurality of desirable diameters.

5. The plasma generation assembly of claim 1, wherein the turns ratio of the coil or solenoid is greater at the outlet end of the plasma generation chamber than at the inlet end of the plasma generation chamber.

6. The plasma generation assembly of claim 1, wherein the plasma generation chamber comprises a plurality of parts that are attached and sealed using a brazing technique, to ensure vacuum-sealing of the plasma generation chamber during operation.

7. The plasma generation assembly of claim 1, wherein the plasma generation chamber comprises a quartz tube.

8. The plasma generation assembly of claim 7, further comprising a mounting flange that connects the external reaction chamber to the plasma generation chamber.

9. The plasma generation assembly of claim 8, wherein the mounting flange is formed out of stainless steel.

10. The plasma generation assembly of claim 8, further comprising bellows that attach the mounting flange to the plasma generation chamber.
